(19) United States
(12) Patent Application Publication
(10) Pub. No.: US 2026/0110484 A1
(43) Pub. Date: Apr. 23, 2026

(54) DRYING APPARATUS AND METHOD FOR CONTROLLING SAME

(71) Applicant: Samsung Electronics Co., Ltd., Suwon-si (KR)

(72) Inventors: Jinsoo CHOI, Suwon-si (KR); Minhee KIM, Suwon-si (KR); Bohwan CHOI, Suwon-si (KR); Youngho RYU, Suwon-si (KR)

(21) Appl. No.: 19/423,209

(22) Filed: Dec. 17, 2025

Related U.S. Application Data
(63) Continuation of application No. PCT/KR2024/095808, filed on May 17, 2024.

(30) Foreign Application Priority Data
Jul. 3, 2023 (KR) 10-2023-0086112
Oct. 27, 2023 (KR) 10-2023-0146080

(51) Int. Cl. F26B 3/347; H05B 6/62

(52) U.S. Cl. CPC F26B 3/347; H05B 6/62

(57) ABSTRACT

A drying apparatus is provided. The drying apparatus includes a chamber, a first electrode and a second electrode arranged in the chamber, and facing each other and spaced apart from each other, a power supply configured to apply a voltage to the first electrode and the second electrode, memory, comprising one or more storage media, storing instructions, and one or more processors communicatively coupled to the power supply, the first electrode, the second electrode, and the memory, wherein the second electrode includes a first sub-electrode and a second sub-electrode that are arranged adjacent to each other in a direction parallel to the first electrode, and wherein the instructions, when executed by the one or more processors individually or collectively, cause the drying apparatus to control the power supply to apply a first voltage to the first sub-electrode and to apply the first voltage or a second voltage to the second sub-electrode, the second voltage having a different phase from the first voltage.

### CROSS-REFERENCE TO RELATED APPLICATION(S)

This application is a continuation application, claiming priority under 35 U.S.C. § 365(c), of an International application No. PCT/KR2024/095808, filed on May 17, 2024, which is based on and claims the benefit of a Korean patent application number 10-2023-0086112, filed on Jul. 3, 2023, in the Korean Intellectual Property Office, and of a Korean patent application number 10-2023-0146080, filed on Oct. 27, 2023, in the Korean Intellectual Property Office, the disclosure of each of which is incorporated by reference herein in its entirety.

### BACKGROUND

### 1. Field

The disclosure relates to a drying apparatus that may dry an object to be dried through dielectric heating, and a method for controlling the same.

### 2. Description of Related Art

A drying apparatus is a device capable of drying an object to be dried by removing moisture contained in the object. There are many different types of drying apparatuses. For example, there are dryers that supply hot air to the inside of a drum accommodating an object to be dried. In the case of the method of supplying hot air into the drum, heat is transferred from air with a low specific heat to water with a high specific heat, resulting in low heat transfer efficiency and, consequently, low drying efficiency. In addition, the high temperature air supplied to the drum may damage the object to be dried.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a drying apparatus that improves a drying uniformity for an object to be dried.

Additional aspects will be set forth in part in the description which follows and, in part, will be apparent from the description, or may be learned by practice of the presented embodiments.

In accordance with an aspect of the disclosure, a drying apparatus is provided. The drying apparatus includes a chamber, a first electrode and a second electrode arranged in the chamber, and facing each other and spaced apart from each other, a power supply configured to apply a voltage to the first electrode and the second electrode, memory, comprising one or more storage media, storing instructions, and one or more processors communicatively coupled to the power supply, the first electrode, the second electrode, and the memory, wherein the second electrode includes a first sub-electrode and a second sub-electrode that are arranged adjacent to each other in a direction parallel to the first electrode, and wherein the instructions, when executed by the one or more processors individually or collectively, cause the drying apparatus to control the power supply to apply a first voltage to the first sub-electrode and to apply the first voltage or a second voltage to the second sub-electrode, the second voltage having a different phase from the first voltage.

In accordance with another aspect of the disclosure, a method for controlling a drying apparatus including a chamber, a first electrode and a second electrode arranged in the chamber, and facing each other and spaced apart from each other, and a power supply configured to apply a voltage to the first electrode and the second electrode, the second electrode including a first sub-electrode and a second sub-electrode that are arranged adjacent to each other in a direction parallel to the first electrode is provided. The method includes controlling the power supply to apply a first voltage to the first sub-electrode and the second sub-electrode, and controlling the power supply to apply the first voltage to the first sub-electrode and to apply a second voltage to the second sub-electrode, the second voltage having a different phase from the first voltage.

In accordance with another aspect of the disclosure, one or more non-transitory computer-readable storage media storing one or more computer programs including computer-executable instructions that, when executed by one or more processors of a drying device individually or collectively, cause the drying device to perform operations are provided. The operations include controlling a power supply of the drying device to apply a first voltage to a first sub-electrode and a second sub-electrode, and controlling the power supply to apply the first voltage to the first sub-electrode and to apply a second voltage to the second sub-electrode, the second voltage having a different phase from the first voltage.

According to an aspect of the disclosure, a drying uniformity of an object to be dried may be improved by controlling a phase of voltage applied to a plurality of electrodes.

According to an aspect of the disclosure, a drying uniformity of an object to be dried may be improved by controlling a phase of voltage applied to a plurality of electrodes based on the power supplied to the electrodes.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a drying apparatus according to an embodiment of the disclosure;

FIG. 2 is a perspective view illustrating a state in which a door is opened in a drying apparatus according to an embodiment of the disclosure;

FIG. 3 is a front cross-sectional view of a drying apparatus illustrated in FIG. 1 according to an embodiment of the disclosure;

FIG. 4 is a front cross-sectional view of a drying apparatus different from FIG. 3 according to an embodiment of the disclosure;

FIG. 5 is a control block diagram of a drying apparatus according to an embodiment of the disclosure;

FIG. 6 illustrates voltages applied to electrodes according to an embodiment of the disclosure;

FIG. 7 illustrates an electric field formed by applying voltages to the electrodes according to FIG. 6 according to an embodiment of the disclosure;

FIG. 8 illustrates voltages applied to electrodes according to an embodiment of the disclosure;

FIG. 9 illustrates an electric field formed by applying voltages to the electrodes according to FIG. 8 according to an embodiment of the disclosure;

FIG. 10 is a flowchart illustrating a method for determining a drying time of a drying apparatus according to an embodiment of the disclosure;

FIG. 11 illustrates drying results according to a voltage applied to electrodes according to an embodiment of the disclosure;

FIG. 12 illustrates an example of determining a drying time based on user input according to an embodiment of the disclosure; and

FIG. 13 illustrates a network system implemented by various electronic devices according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used herein are for the purpose of describing the embodiments and are not intended to restrict and/or to limit the disclosure.

For example, the singular expressions herein may include plural expressions, unless the context clearly dictates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

It will be understood that the terms “first,” “second,” etc., may be used only to distinguish one component from other components, and are not intended to limit the corresponding component in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

When a given element is referred to as being “connected to,” “coupled to,” “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when one component is referred to as being “on” or “over” another component, it can be directly on the other component or intervening components may also be present.

Further, the terms such as “˜portion,” “˜device,” “˜block,” “˜member,” “˜module,” and the like may refer to a unit for processing at least one function or act. For example, the terms may refer to at least one process processed by at least one hardware, such as field-programmable gate array (FPGA)/application specific integrated circuit (ASIC), software stored in memories or processors.

Hereinafter, a drying apparatus according to various embodiments will be described in detail with reference to accompanying drawings.

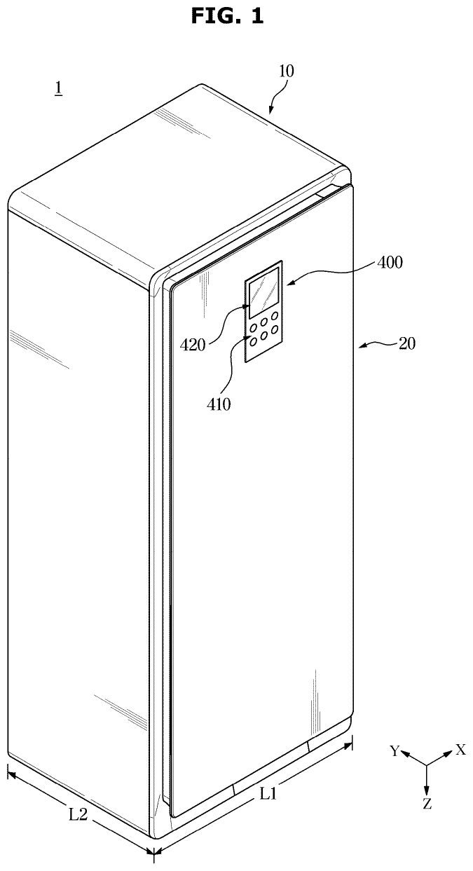

FIG. 1 is a perspective view of a drying apparatus according to an embodiment of the disclosure.

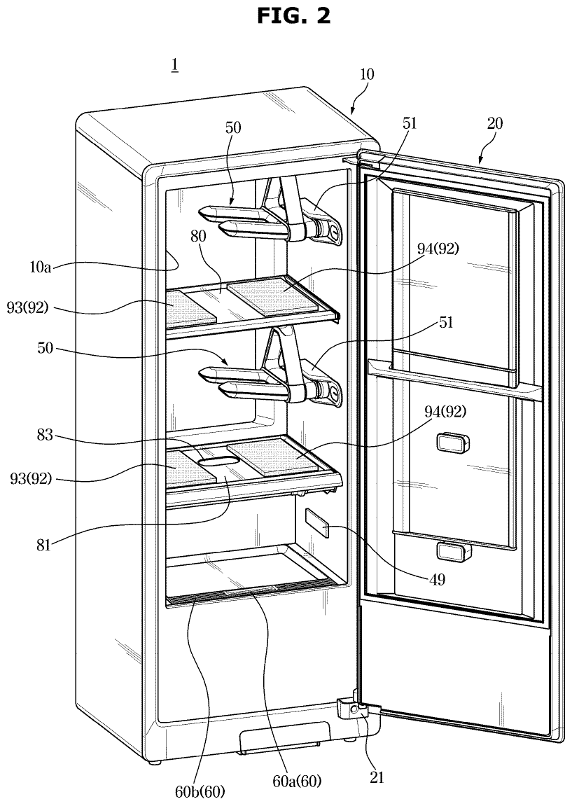

FIG. 2 is a perspective view illustrating a state in which a door is opened in a drying apparatus according to an embodiment of the disclosure.

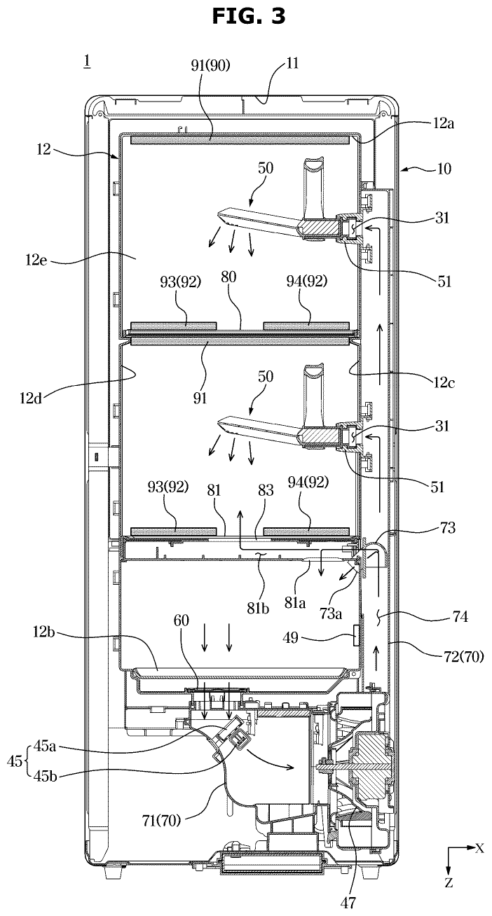

FIG. 3 is a front cross-sectional view of the drying apparatus illustrated in FIG. 1 according to an embodiment of the disclosure.

Referring to FIGS. 1 to 3, a drying apparatus 1 may include a main body 10 forming an exterior and a door 20 rotatably coupled to the main body 10.

The main body 10 may be provided in a rectangular parallelepiped shape with an open front surface. An opening 10a may be formed in the open front surface of the main body 10. The door 20 may be provided to open and close the open front surface of the main body 10 by being rotatably coupled to the main body 10. The door 20 may be coupled to the main body 10 by a hinge 21.

The main body 10 may be formed such that a length of the front surface extending in the first direction X is different from a length of a side surface extending in the second direction Y. That is, the length L1 of the front surface of the main body 10 may be longer than the length L2 of the side surface of the main body 10. Accordingly, the drying apparatus 1 may be easily installed even in a narrow entrance. The length of the front surface of the main body 10 may be defined as the first length L1, and the length of the side surface of the main body 10 may be defined as the second length L2.

The door 20 may include a user interface 400 provided on the front surface and/or an upper surface. The user interface 400 may include an input interface 410 for obtaining a user input and/or an output interface 420 for transmitting various information related to an operation of the drying apparatus 1 to the user.

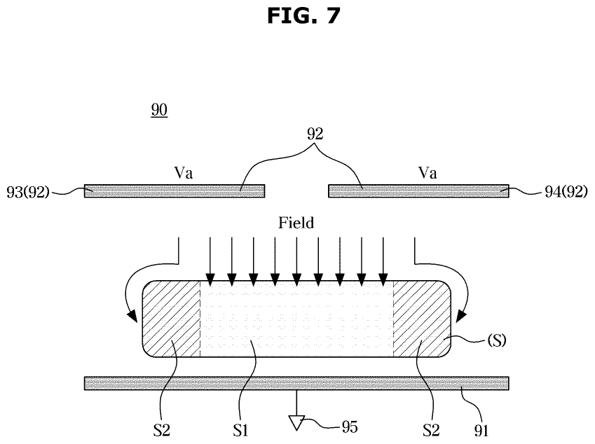

The main body 10 may include an outer case 11 and an inner case 12 disposed inside the outer case 11. A chamber 30, which is a space in which an object to be dried S (see FIG. 7) is accommodated, may be formed inside the main body 10. For example, the inner case 12 may form the chamber 30. A holder 50 capable of holding the object to be dried S (hereinafter, also referred to as ‘drying object S’) may be provided inside the chamber 30. The inner case 12 may be referred to as the case.

The chamber 30 may be formed by an upper surface 12a, a lower surface 12b, a left surface 12c, a right surface 12d, and a rear surface 12e of the inner case 12. The drying object S may be accommodated and cared for in the chamber 30. The upper surface 12a, the lower surface 12b, the left surface 12c, the right surface 12d, and the rear surface 12e of the inner case 12 may be the upper wall 12a, the lower wall 12b, the left wall 12c, the right wall 12d, and the rear wall 12e of the inner case 12, respectively.

The holder 50 and a mounting rail 51 may be provided in the chamber 30. The holder 50 and the mounting rail 51 may be installed on the left surface 12c or the right surface 12d of the inner case 12. That is, the holder 50 may be installed such that a side of the drying object S is visible when viewed from the front of the drying apparatus 1. To this end, the length of the side surface of the main body 10 may be shorter than the length of the front surface of the main body 10. However, the positions of the holder 50 and the mounting rail 51 are not limited to those illustrated.

One or more of the holders 50 may be provided. The holder 50 may be provided in a shape that allows the drying object S to be mounted on the holder 50. In addition, the holder 50 is separable from the chamber 30. That is, the holder 50 may be coupled to the mounting rail 51 provided on the side surface of the chamber 30, and may be separated from the mounting rail 51. For example, the holder 50 may be inserted into the mounting rail 51 along the second direction Y. Because the holder 50 is separable, the space in the chamber 30 may be used efficiently depending on a size of the drying object S.

The drying apparatus 1 may include an air outlet 31 and an air inlet 60. The air outlet 31 may be formed on a side wall of the inner case 12. For example, the air outlet 31 may be formed on the left surface 12c of the chamber 30. A plurality of the air outlets 31 may be provided. The air outlet 31 may allow air that has passed through a duct 70 to flow out into the chamber 30.

The air inlet 60 may be formed on one side surface of the inner case 12. For example, the air inlet 60 may be formed on the lower surface 12b of the inner case 12. Specifically, the air inlet 60 may be disposed in front of the lower surface 12b. Air in the chamber 30 may be introduced into the duct 70 through the air inlet 60. The air inlet 60 may include a grill 60b including a central hole 60a and a plurality of side holes.

The duct 70 may be provided on one side of the chamber 30. For example, the duct 70 may be disposed below the chamber 30, on the left wall 12c and/or the right wall 12d. A deodorizing device 45 and a blower fan 47 may be provided in the duct 70.

The duct 70 may include a first duct 71 located below the chamber 30. The first duct 71 may form a flow path connected to the air inlet 60 of the chamber 30 and guiding air passed through the air inlet 60 to the blower fan 47. The duct 70 may include a second duct 72 provided on the left wall 12c and/or the right wall 12d forming the chamber 30. The first duct 71 may be connected to the second duct 72 provided on a side wall of the main body 10.

One end of the second duct 72 may be connected to at least one of the air outlets 31, and the other end may be connected to the first duct 71. The second duct 72 may form an exhaust flow path 74 guiding air to the air outlet 31.

The blower fan 47 may be disposed between the first duct 71 and the second duct 72 to circulate air. The blower fan 47 may rotate based on a predetermined revolutions per minute (RPM). Specifically, the blower fan 47 may draw in air introduced into the first duct 71 and discharge the air toward the second duct 72. The air introduced into the first duct 71 through the air inlet 60 may be discharged back to the chamber 30 through the second duct 72 and the air outlet 31.

In addition, the deodorizing device 45 may be disposed inside the first duct 71. The deodorizing device 45 may include a deodorizing filter 45a and an ultraviolet light emitting diode (UV LED) 45b. The deodorizing filter 45a and the UV LED 45b may be disposed close to the air inlet 60 of the chamber 30. The UV LED 45b may remove odors contained in air by irradiating light to the deodorizing filter 45a. For example, the deodorizing filter 45a may include at least one of a ceramic filter, a photocatalytic filter, or an activated carbon filter.

A sterilizing device 49 may be further disposed inside the chamber 30. The sterilizing device 49 may remove bacteria contained in air. The sterilizing device 49 may include at least one of an ultraviolet lamp, an ultraviolet LED, a xenon lamp, an ozone generator, or a disinfectant spray.

At least one shelf 80 and at least one duct shelf 81 may be provided in the chamber 30. The drying object S may be placed on the shelf 80 and/or the duct shelf 81. The duct shelf 81 may form a duct flow path 81b therein, and may include a lower hole 81a formed on a lower surface thereof. Air blown from the blower fan 47 through the second duct 72 may be discharged into the chamber 30 through the lower hole 81a of the duct shelf 81. An upper hole 83 may also be provided on an upper surface of the duct shelf 81.

A side surface of the duct shelf 81 may be connected to a circular duct 73 disposed inside the second duct 72. Air may be discharged into the chamber 30 through a nozzle 73a of the circular duct 73. Air may be supplied to the duct shelf 81 after passing through the circular duct 73. The circular duct 73 may have various shapes.

At least one first electrode 91 and at least one second electrode 92 facing each other and spaced apart from each other may be provided in the chamber 30. The first electrode 91 may be provided on one side of the chamber 30 and/or one side of the shelf 80. For example, the first electrode 91 may be provided on the upper surface 12a of the inner case 12. In another example, the first electrode 91 may be attached to the lower surface of the shelf 80.

The second electrode 92 may be provided on one side of the chamber 30, one side of the shelf 80, and/or one side of the duct shelf 81. For example, the second electrode 92 may be provided on the upper surface of the shelf 80. In another example, the second electrode 92 may be provided on the upper surface of the duct shelf 81.

The second electrode 92 may include at least one first sub-electrode 91 and at least one second sub-electrode 94 arranged adjacent to each other in a direction parallel to the first electrode 91. For example, the first sub-electrode 93 and the second sub-electrode 94 may be arranged on the upper surface of the shelf 80 so as to be adjacent to each other in a direction parallel to the first electrode 91. In another example, the first sub-electrode 93 and the second sub-electrode 94 may be arranged side by side on the upper surface of the duct shelf 81 so as to be adjacent to each other in a direction parallel to the first electrode 91.

In addition, the first sub-electrode 93 and the second sub-electrode 94 may be located in various manners according to various embodiments. For example, the first sub-electrode 93 may be disposed adjacent to the second sub-electrode 94, while surrounding an outer edge of the second sub-electrode 94. In another example, the second sub-electrode 94 may be disposed adjacent to the first sub-electrode 93, while surrounding an outer edge of the first sub-electrode 93.

When a voltage is applied to the first electrode 91 and the second electrode 92, an electric field may be formed between the first electrode 91 and the second electrode 92. The electric field formed between the first electrode 91 and the second electrode 92 may cause polar molecules, such as water molecules, inside the drying object S exposed to the electric field, to vibrate. Due to the vibration of the polar molecules, heat is generated. Because water generally has a high dielectric constant, moisture contained in the drying object S exposed to the electric field may be heated and evaporated relatively quickly. Accordingly, moisture in the drying object may be removed.

The first electrode 91 may function as a common electrode for the first sub-electrode 93 and the second sub-electrode 94. For example, in a case where the first electrode 91 and the first sub-electrode 93 are a pair of electrodes and a voltage is applied to the first electrode 91 and the first sub-electrode 93, an electric field may be formed between the first electrode 91 and the first sub-electrode 93. Also, in a case where the first electrode 91 and the second sub-electrode 94 are a pair of electrodes and a voltage is applied to the first electrode 91 and the second sub-electrode 94, an electric field may be formed between the first electrode 91 and the second sub-electrode 94.

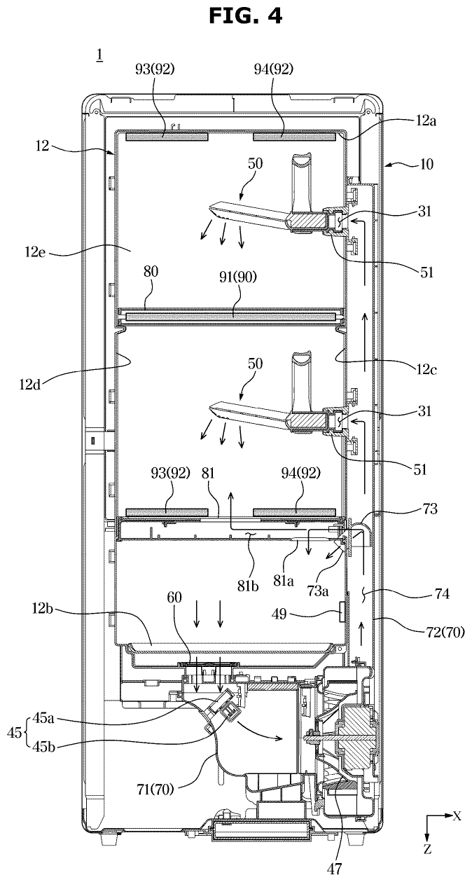

FIG. 4 is a front cross-sectional view of a drying apparatus different from FIG. 3 according to an embodiment of the disclosure.

Referring to FIG. 4, the first electrode 91 may be formed inside the shelf 80. The second electrode 92 may be formed on the upper surface 12a of the inner case 12 and/or the upper surface of the duct shelf 81.

The first electrode 91 may function as a common electrode for the plurality of second electrodes 92. For example, the first electrode 91 may function as a common electrode for the second electrode 92, provided on the upper surface 12a of the inner case 12, and the second electrode 92 provided on the upper surface of the duct shelf 81.

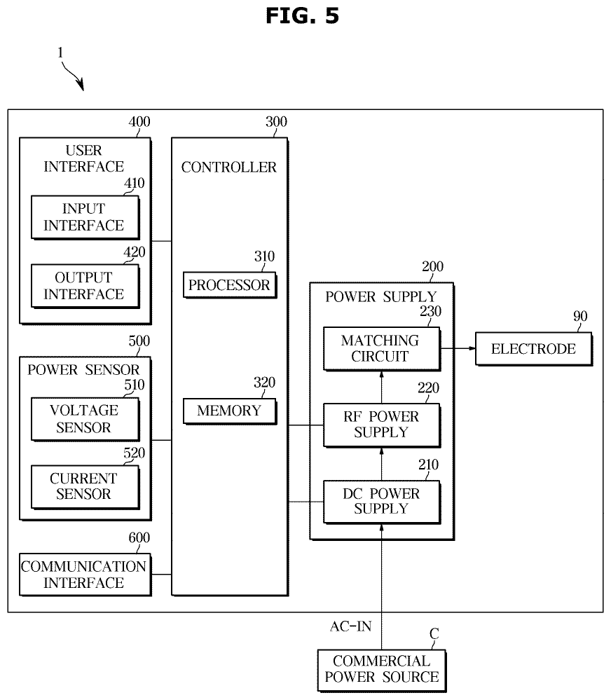

FIG. 5 is a control block diagram of a drying apparatus according to an embodiment of the disclosure.

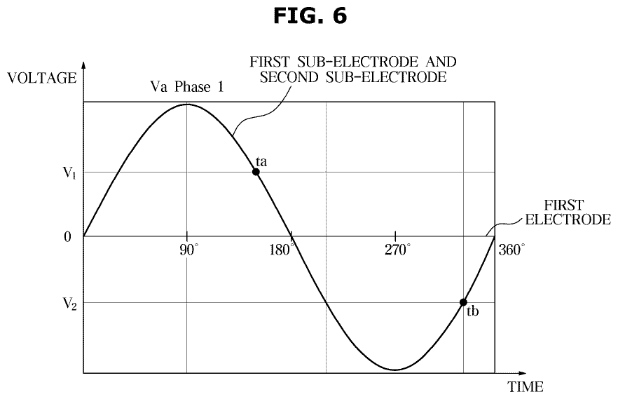

FIG. 6 illustrates the voltages applied to electrodes according to an embodiment of the disclosure.

FIG. 7 illustrates an electric field formed by applying voltages to the electrodes according to FIG. 6 according to an embodiment of the disclosure.

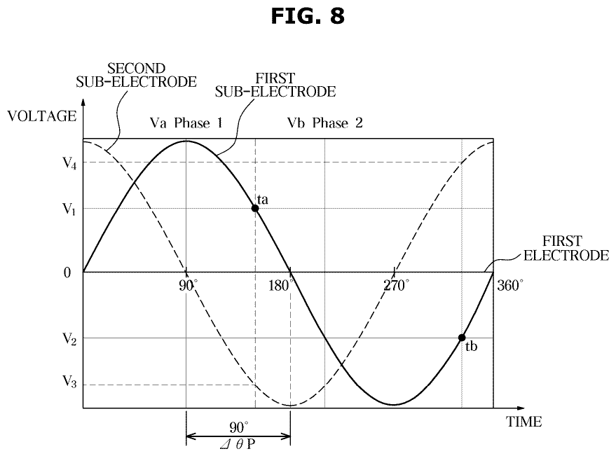

FIG. 8 illustrates the voltages applied to electrodes according to an embodiment of the disclosure.

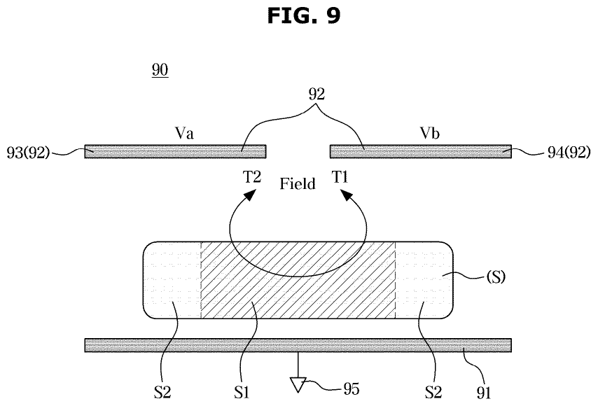

FIG. 9 illustrates an electric field formed by applying voltages to the electrodes according to FIG. 8 according to an embodiment of the disclosure.

Referring to FIG. 5, the drying apparatus 1 may include electrodes 90, a power supply 200 applying a voltage to the electrodes 90 to form an electric field in the chamber 30, the user interface 400 obtaining user input or displaying various information related to the operation of the drying apparatus 1, a power sensor 500 measuring the voltage and/or current supplied by or to each component of the drying apparatus 1, a communication interface 600 establishing communication with an external device, and/or a controller 300 controlling the power supply 200, the user interface 400, the power sensor 500, and/or the communication interface 600.

The power supply 200 may include a direct current (DC) power supply 210 transmitting DC power to a radio frequency (RF) power supply 220, the RF power supply 220 generating an RF signal for applying a voltage to the electrodes 90, and/or a matching circuit 230 for matching an output impedance of the RF power supply 220 with an electrode impedance of each of the plurality of electrodes 90.

The DC power supply 210 may convert alternating current (AC) power supplied from a commercial power source C into DC power, and may supply the DC power to the RF power supply 220.

The RF power supply 220 may generate an RF signal and apply the RF signal to the electrodes 90. The matching circuit 230 may be arranged between the RF power supply 220 and the plurality of electrodes 90. The RF signal generated by the RF power supply 220 may be transmitted to the electrodes 90 through the matching circuit 230. A sinusoidal voltage may be applied to the electrodes 90 by the RF signal.

The matching circuit 230 may match the output impedance of the RF power supply 220 with the electrode impedance of each of the plurality of electrodes 90. The matching circuit 230 may include a variable inductor and a variable capacitor. In a case where there is a difference between the output impedance of the RF power supply 220 and the electrode impedance of each of the electrodes 90, reflected power is generated from the electrodes 90 and power transfer efficiency is reduced. In order to minimize the reflected power, matching of the output impedance of the RF power supply 220 and the electrode impedance of each of the electrodes 90 requires to be performed. The controller 300 may control the matching circuit 230 to perform impedance matching.

The DC power supply 210, the RF power supply 220, and the matching circuit 230 may be provided as a single power module. In other words, the DC power supply 210 and the matching circuit 230 may be included in the RF power supply 220. The single power module may be common to the plurality of electrodes 90, and the plurality of electrodes 90 may be connected in parallel to the single power module.

In addition, a plurality of DC power supplies 210, a plurality of RF power supplies 220, and a plurality of matching circuits 230 corresponding to the plurality of electrodes 90 may be provided. That is, a plurality of power modules including the DC power supplies 210, the RF power supplies 220, and the plurality of matching circuits 230 may be provided. Each of the plurality of electrodes 90 may be independently connected to each of the power modules.

The controller 300 may include a processor 310 and memory 320. The memory 320 may include volatile memory (e.g., static random-access memory (S-RAM), dynamic random-access memory (D-RAM)) and non-volatile memory (e.g., read-only memory (ROM), erasable programmable read-only memory (EPROM)). The processor 310 and the memory 320 may be implemented as separate chips or as a single chip. In addition, a plurality of processors and a plurality of memories may be provided. The processor 310 may process various data and signals using instructions, data, programs, and/or software stored in the memory 320. The processor 310 may generate control signals for controlling components of the drying apparatus 1. The processor 310 may include a single core or a plurality of cores.

The controller 300 may control the DC power supply 210 to adjust the magnitude of the voltage applied to the electrodes 90. As the power supplied to the RF power supply 220 increases, the amplitude of the RF signal may increase and the magnitude of the voltage applied to the electrodes 90 may increase. The magnitude of the voltage may be represented by an effective value.

The controller 300 may control the RF power supply 220 to adjust the phase of the voltage applied to the electrodes 90.

Referring to FIGS. 6 and 7, the first electrode 91 may be connected to a ground terminal 95.

The controller 300 may control the power supply 200 to allow a ground voltage of 0V magnitude and 0° phase to be applied to the first electrode 91 through the ground terminal 95. The first electrode 91 may function as a common electrode for the first sub-electrode 93 and the second sub-electrode 94.

The controller 300 may control the power supply 200 to allow a voltage to be applied to the first sub-electrode 93 and/or the second sub-electrode 94. The voltage applied to the second electrode 92 may include an alternating current voltage in which the magnitude and phase of the voltage periodically change over time.

The controller 300 may control the power supply 200 to allow a first voltage Va to be applied to the first sub-electrode 93 and the second sub-electrode 94. That is, the first voltage Va having the same magnitude and phase may be applied to the first sub-electrode 93 and the second sub-electrode 94, respectively.

In a case where the first voltage Va having the same magnitude and phase is applied to the first sub-electrode 93 and the second sub-electrode 94, at any point in time, a potential difference between the first sub-electrode 93 and the first electrode 91 is the same as a potential difference between the second sub-electrode 94 and the first electrode 91. For example, at a first time point ta, a potential difference V1 between the first sub-electrode 93 and the first electrode 91 is the same as the potential difference V1 between the second sub-electrode 94 and the first electrode 91, and at a second time point tb, which is different from the first time point ta, a potential difference V2 between the first sub-electrode 93 and the first electrode 91 is the same as the potential difference V2 between the second sub-electrode 94 and the first electrode 91.

In a case where the potential difference between the first sub-electrode 93 and the first electrode 91 and the potential difference between the second sub-electrode 94 and the first electrode 91 are the same at any point in time, equipotential surfaces may be formed in a direction parallel to the first electrode 91 and the second electrode 92, and an electric field may be formed in a direction perpendicular to the first electrode 91 and the second electrode 92, which is perpendicular to the equipotential surfaces. That is, a vertical electric field may be formed.

In a case where a vertical electric field is formed, the electric field may become distorted at edge portions S1 of a drying object S and concentrated on edge portions S2 of the drying object S. Accordingly, the dryness of the edge portions S2 of the drying object S may be higher than that of the center portion S1 of the drying object S.

Referring to FIG. 8, the controller 300 may control the power supply 200 to apply the first voltage Va to the first sub-electrode 93, and the second voltage Vb to the second sub-electrode 94. The second voltage Vb has a different phase from the first voltage Va. The phase difference between the first voltage Va and the second voltage Vb may be determined to be 90°.

Referring to FIG. 9, when voltages with different phases are applied to the first sub-electrode 93 and the second sub-electrode 94, at a specific time point, a potential difference between the first sub-electrode 93 and the first electrode 91 may be different from a potential difference between the second sub-electrode 94 and the first electrode 91. For example, at a first time point ta, a potential difference V1 between a voltage V1 applied to the first sub-electrode 93 and a ground voltage 0V applied to the first electrode 91 may be different from a potential difference V3 between a voltage V3 applied to the second sub-electrode 94 and the ground voltage 0V applied to the first electrode 91. In another example, at a second time point tb, a potential difference V2 between a voltage V2 applied to the first sub-electrode 93 and the ground voltage 0V applied to the first electrode 91 may be different from a potential difference V4 between a voltage V4 applied to the second sub-electrode 94 and the ground voltage 0V applied to the first electrode 91.

Accordingly, in a case where the potential difference between the first sub-electrode 93 and the first electrode 91 is higher than the potential difference between the second sub-electrode 94 and the first electrode 91, the electric field may be formed in a counterclockwise direction T1 from the first sub-electrode 93 through the first electrode 91 to the second sub-electrode 94. In a case where the potential difference between the second sub-electrode 94 and the first electrode 91 is higher than the potential difference between the first sub-electrode 93 and the first electrode 91, the electric field may be formed in a clockwise direction T2 from the second sub-electrode 94 through the first electrode 91 to the first sub-electrode 93. That is, a rotating electric field in which the electric field rotates in the space between the first electrode 91 and the second electrode 92 may be formed.

When a rotating electric field is formed, the electric field may become distorted at the center portion S1 of the drying object S and concentrated on the center portion S1 of the drying object S. Accordingly, the electric field is applied more deeply into the center portion S1 of the drying object S than when a vertical electric field is formed, and thus the dryness of the center portion S1 of the drying object S may be improved.

In an embodiment, the controller 300 may control the power supply 200 to apply the first voltage Va to the first sub-electrode 93, and to apply the first voltage Va or the second voltage Vb, which has a different phase from the first voltage Va, to the second sub-electrode 94.

For example, while the first voltage Va is applied to the first sub-electrode 93, the controller 300 may control the power supply 200 to apply the first voltage Va having the same magnitude and phase to the second sub-electrode 94, or to apply the second voltage Vb having the same magnitude but a different phase to the second sub-electrode 94.

In an embodiment, the controller 300 may control the power supply 200 to apply a ground voltage to the first electrode 91, and

to apply the first voltage Va to the first sub-electrode 93 and the second sub-electrode 94 in order to form a vertical electric field between the first electrode 91 and the second electrode 92, or to apply the first voltage Va to the first sub-electrode 93 and the second voltage Vb to the second sub-electrode 94 in order to form a rotating electric field between the first electrode 91 and the second electrode 92.

For example, while the ground voltage is applied to the first electrode 91, the controller 300 may control the power supply 200 to apply the first voltage Va having the same magnitude and phase to the first sub-electrode 93 and the second sub-electrode 94, and may control the power supply 200 to apply the first voltage Va to the first sub-electrode 93 and the second voltage Vb, which has a different phase from the first voltage Va.

In an embodiment, the controller 300 may control the power supply 200 such that the first voltage Va is applied to the first sub-electrode 93, and the first voltage Va and the second voltage Vb are alternately applied to the second sub-electrode 94.

For example, while the first voltage Va is applied to the first sub-electrode 93, the controller 300 may control the power supply 200 to apply the first voltage Va to the second sub-electrode 94, and then to apply the second voltage Vb, which has the same magnitude but a different phase, to the second sub-electrode 94.

In another example, while the first voltage Va is applied to the first sub-electrode 93, the controller 300 may control the power supply 200 to apply the first voltage Va to the second sub-electrode 94, then apply the second voltage Vb, which has the same magnitude but a different phase, to the second sub-electrode 94, and then apply the first voltage Va again to the second sub-electrode 94.

In an embodiment, the controller 300 may control the power supply 200 such that the first voltage Va is applied to the first sub-electrode 93 and the second sub-electrode 94 during a first drying time, and the first voltage Va is applied to the first sub-electrode 93 and the second voltage Vb is applied to the second sub-electrode 94 during a second drying time. The total drying time may be the sum of the first drying time and the second drying time.

For example, the controller 300 may control the power supply 200 to apply the first voltage Va having the same magnitude and phase to the first sub-electrode 93 and the second sub-electrode 94 during the first drying time of the total drying time, and to apply the first voltage Va and the second voltage Vb, which have the same magnitude but different phases, to the first sub-electrode 93 and the second sub-electrode 94, respectively, during the second drying time of the total drying time.

The user interface 400 may include an input interface 410 for obtaining user input and/or an output interface 420 for transmitting various information related to the operation of the drying apparatus 1 to a user.

The input interface 410 may convert input information received from the user into electrical signals.

The input interface 410 may include, for example, a tact switch, a push switch, a slide switch, a toggle switch, a micro switch, a touch switch, a touch pad, a touch screen, a jog dial, and/or a microphone.

The output interface 420 may transmit various information related to the operation of the drying apparatus 1 to the user.

Information related to the operation of the drying apparatus 1 may be output as a screen, an indicator, voice, and the like. The output interface 420 may include, for example, a liquid crystal display (LCD) panel, a light emitting diode (LED) panel, and a speaker.

The power sensor 500 may include a voltage sensor 510 measuring the voltage supplied by or to each component of the drying apparatus 1, and/or a current sensor 520 measuring the current supplied by or to each component of the drying apparatus 1.

The voltage sensor 510 may be connected to the DC power supply 210 and the RF power supply 220, and may measure the voltage supplied by the DC power supply 210 to the RF power supply 220. The current sensor 520 may be connected to the DC power supply 210 and the RF power supply 220, and may measure the current supplied by the DC power supply 210 to the RF power supply 220.

The controller 300 may determine the power supplied to the first electrode 91 and the second electrode 92 based on the voltage measured by the voltage sensor 510 and the current measured by the current sensor 520.

The communication interface 600 may communicate with an external device via a network. The controller 300 may obtain various information, various signals, and/or various data from the external device through the communication interface 600. For example, the communication interface 600 may receive a remote control signal from the external device. The controller 300 may obtain firmware and/or software for the operation of the drying apparatus 1 from the external device through the communication interface 600.

The communication interface 600 may include various communication circuits. The communication interface 600 may include a wireless communication circuit and/or a wired communication circuit. For example, a communication circuit that supports wireless communication methods such as wireless local area network (LAN), Home radio frequency (Home RF), infrared communication, Ultra-wide band (UWB) communication, Wi-Fi, Bluetooth, and Zigbee may be provided.

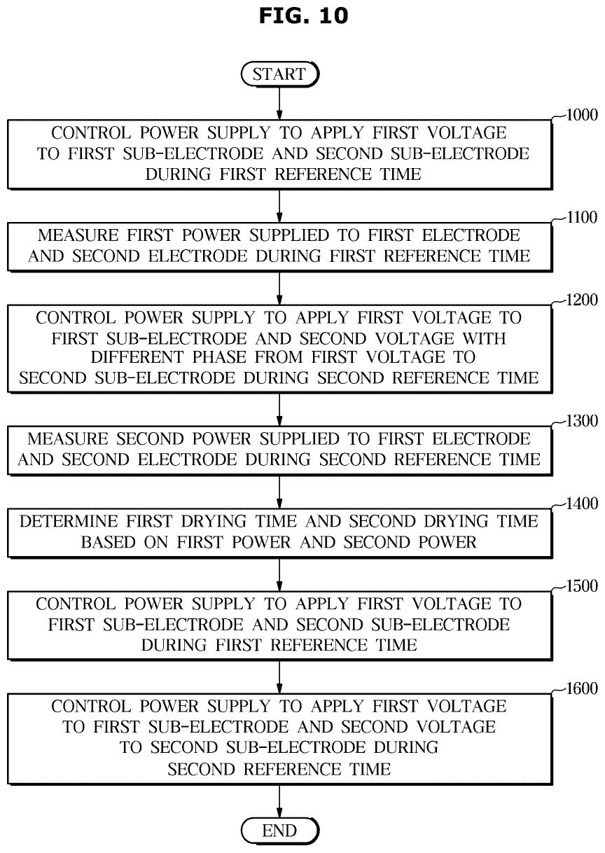

FIG. 10 is a flowchart illustrating a method for determining a drying time of a drying apparatus according to an embodiment of the disclosure.

Referring to FIG. 10, the controller 300 may control the power supply 200 to apply the first voltage Va to the first sub-electrode 93 and the second sub-electrode 94 during a first reference time at operation 1000. The power sensor 500 may measure a first power supplied to the first electrode 91 and the second electrode 92 during the first reference time at operation 1100. The first power measured by the power sensor 500 may be a value corresponding to the product of the voltage, supplied by the DC power supply 210 to the RF power supply 220 during the first reference time, as measured by the voltage sensor 510, and the current, supplied by the DC power supply 210 to the RF power supply 220 during the first reference time, as measured by the current sensor 520.

The controller 300 may control the power supply 200 to apply the first voltage Va to the first sub-electrode 93 and the second voltage Vb to the second sub-electrode 94 during a second reference time at operation 1200. The power sensor 500 may measure a second power supplied to the first electrode 91 and the second electrode 92 during the second reference time at operation 1300. The second power measured by the power sensor 500 may be a value corresponding to the product of the voltage supplied by the DC power supply 210 to the RF power supply 220 during the second reference time, as measured by the voltage sensor 510, and the current supplied by the DC power supply 210 to the RF power supply 220 during the second reference time, as measured by the current sensor 520.

The first reference time and the second reference time may be the same, and the order of the first reference time and the second reference time is not limited to the above. For example, the controller 300 may control the power supply 200 to apply the first voltage Va to the first sub-electrode 93 and the second voltage Vb to the second sub-electrode 94 during the second reference time, and then to apply the first voltage Va to the first sub-electrode 93 and the second sub-electrode 94 during the first reference time.

The controller 300 may determine a first drying time and a second drying time based on the power supplied to the first electrode 91 and the second electrode 92.

In an embodiment, the controller 300 may determine the first drying time and the second drying time based on the first power and the second power at operation 1400.

In order for the same power to be applied to the first electrode 91 and the second electrode 92 during the first drying time and the second drying time, the controller 300 may determine the first drying time and the second drying time based on a ratio of the second power to the first power.

For example, the controller 300 may determine the first drying time and the second drying time such that the ratio of the second drying time to the first drying time has a value corresponding to the reciprocal of the ratio of the second power to the first power.

The controller 300 may control the power supply 200 to apply the first voltage Va to the first sub-electrode 93 and the second sub-electrode 94 during the determined first drying time at operation 1500.

The controller 300 may control the power supply 200 to apply the first voltage Va to the first sub-electrode 93 and the second voltage Vb to the second sub-electrode 94 during the determined second drying time at operation 1600.

The order of the first drying time and the second drying time is not limited to the above. For example, the controller 300 may control the power supply 200 to apply the first voltage Va to the first sub-electrode 93 and the second voltage Vb to the second sub-electrode 94 during the second drying time, and then to apply the first voltage Va to the first sub-electrode 93 and the second sub-electrode 94 during the first drying time.

In an embodiment, at every reference period (e.g., 15 minutes), the controller 300 may control the power supply 200 to apply the first voltage Va to the first sub-electrode 93 and the second sub-electrode 94 during the first reference time, and to apply the first voltage Va to the first sub-electrode 93 and the second voltage Vb to the second sub-electrode 94 during the second reference time, may determine the first drying time and the second drying time based on the first power, supplied to the first electrode 91 and the second electrode 92 during the first reference time, and the second power supplied to the first electrode 91 and the second electrode 92 during the second reference time, and may control the power supply 200 to apply the first voltage Va to the first sub-electrode 93 and the second sub-electrode 94 during the determined first drying time, and to apply the first voltage Va to the first sub-electrode 93 and the second voltage Vb to the second sub-electrode 94 during the second drying time.

For example, in a case where the ratio of the first power and the second power measured after the reference period (e.g., 15 minutes) has changed, the controller 300 may re-determine the first drying time and the second drying time, and control the power supply 200 to apply voltages to the first sub-electrode 93 and the second sub-electrode 94 according to the re-determined first drying time and second drying time.

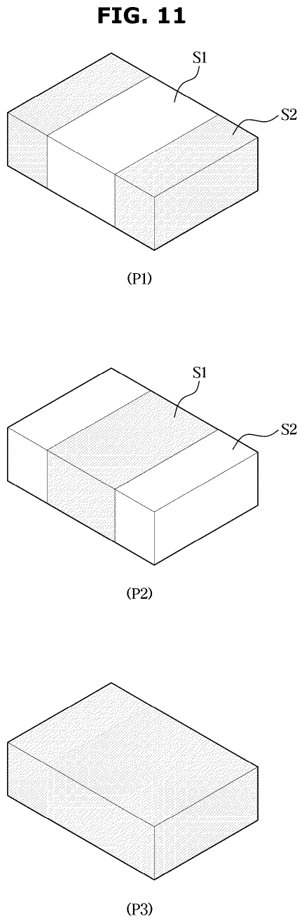

FIG. 11 illustrates drying results according to a voltage applied to electrodes according to an embodiment of the disclosure.

Referring to FIG. 11, in a case where the first voltage Va having the same magnitude and phase is applied to the first sub-electrode 93 and the second sub-electrode 94 during the entire drying time, a vertical electric field is formed in the space between the first electrode 91 and the second electrode 92, and thus the dryness of the edge portions S2 of the drying object S may be higher than that of the center portion S1 (P1).

In a case where the first voltage Va is applied to the first sub-electrode 93 and the second voltage Vb, which has a different phase from the first voltage Va, is applied to the second sub-electrode 94 during the entire drying time, a rotating electric field is formed in the space between the first electrode 91 and the second electrode 92, and thus the dryness of the center portion S1 of the drying object S may be higher than that of the edge portions S2 (P2).

In a case where the first voltage Va is applied to the first sub-electrode 93 and the first voltage Va and the second voltage Vb are alternately applied to the second sub-electrode 94 during the entire drying time, a vertical electric field and a rotating electric field are alternately formed in the space between the first electrode 91 and the second electrode 92, and thus the center portion S1 and the edge portions S2 of the drying object S may be uniformly dried (P3).

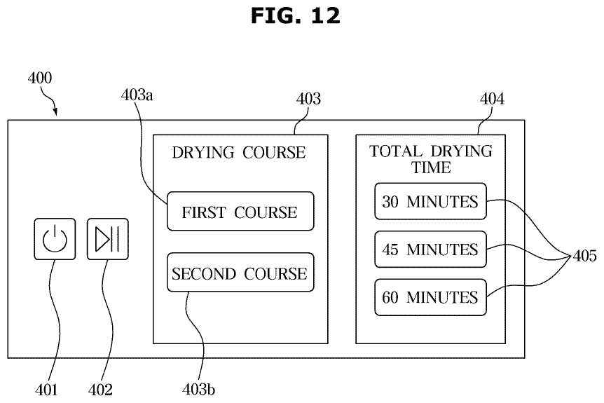

FIG. 12 illustrates an example of determining a drying time based on user input according to an embodiment of the disclosure.

Referring to FIG. 12, the user interface 400 may display a power button 401 for turning on/off the drying apparatus 1, a start/stop button 402 for starting or stopping a drying operation, a drying course button 403 for selecting a drying course, and/or a drying time input button 404 for setting a total drying time through a display.

In various embodiments, the controller 300 may perform various functions based on control signals received via the user interface 400.

In an embodiment, the controller 300 may turn on/off the drying apparatus 1 based on the user's power On/Off input signal.

For example, the controller 300 may turn on/off the drying apparatus 1 based on an input signal generated when a user presses the power button 401.

In an embodiment, the controller 300 may start or stop operating the drying apparatus 1 based on an input signal for starting or stopping the operation of the drying apparatus 1.

For example, the controller 300 may control the power supply 200 such that a voltage is applied or not applied to the plurality of electrodes 90 based on an input signal generated when a user presses the start/stop button 402.

In an embodiment, the controller 300 may control the power supply 200 to apply a voltage(s) to the plurality of electrodes 90 based on the total drying time input by the user.

For example, the controller 300 may control the power supply 200 to apply a voltage(s) to the plurality of electrodes 90 based on an input signal corresponding to a drying time button 405 pressed by the user among the drying time buttons 404.

In various embodiments, the controller 300 may control the power supply 200 to apply a voltage(s) to the plurality of electrodes 90 based on the drying course selected by the user. The drying course may include a first course 403a and/or a second course 403b in which the drying time is determined based on the drying purpose of the drying object S. The first course 403a may be a drying course selected when the center portion S1 of the drying object S requires to be dried more (e.g., a course for drying thick objects). The second course 403b may be a drying course selected when the edge portions S2 of the drying object S require to be dried more (e.g., a course for wet shoes).

In an embodiment, the controller 300 may determine a first drying time and a second drying time based on the drying course selected by the user, and control the power supply 200 to apply the first voltage Va to the first sub-electrode 93 and the second sub-electrode 94 during the first drying time, and to apply the first voltage Va to the first sub-electrode 93 and the second voltage Vb to the second sub-electrode 94 during the second drying time.

For example, based on the first course 403a being selected by the user, the controller 300 may control the power supply 200 to apply the first voltage Va to the first sub-electrode 93 and the second sub-electrode 94 during the first drying time, and to apply the first voltage Va to the first sub-electrode 93 and the second voltage Vb to the second sub-electrode 94 during the second drying time which is longer than the first drying time.

In another example, based on the second course 403b being selected by the user, the controller 300 may control the power supply 200 to apply the first voltage Va to the first sub-electrode 93 and the second voltage Vb to the second sub-electrode 94 during the second drying time, and to apply the first voltage Va to the first sub-electrode 93 and the second sub-electrode 94 during the first drying time which is longer than the second drying time.

In still another example, based on the first course 403a being selected by the user, the controller 300 may control the power supply 200 to apply the first voltage Va to the first sub-electrode 93 and the second voltage Vb to the second sub-electrode 94 during the entire drying time.

In yet another example, based on the second course 403b being selected by the user, the controller 300 may control the power supply 200 to apply the first voltage Va to the first sub-electrode 93 and the second sub-electrode 94 during the entire drying time.

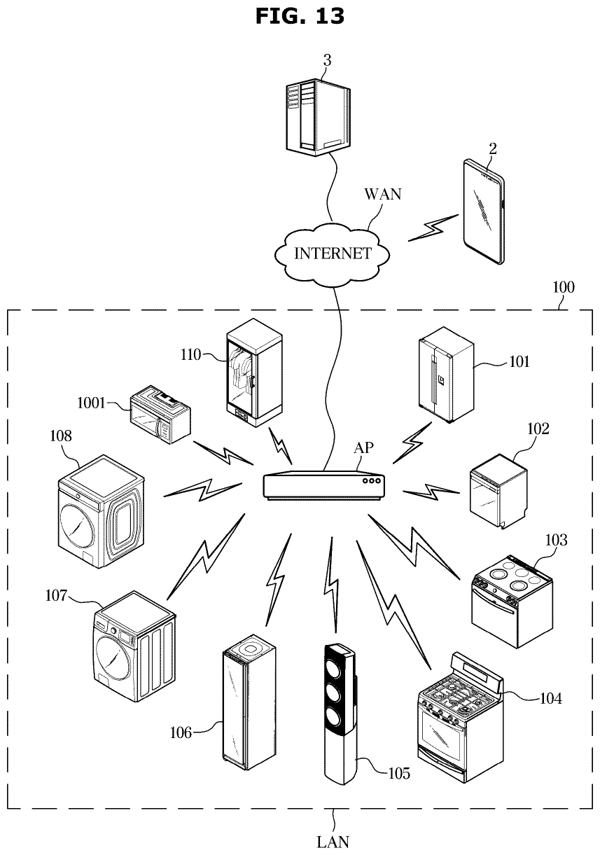

FIG. 13 illustrates a network system implemented by various electronic devices according to an embodiment of the disclosure.

The above-described drying apparatus 1 may correspond to a home appliance 100 described below.

Referring to FIG. 13, the home appliance 100 may include a communication interface (e.g., the communication interface 600) capable of communicating with another home appliance, a user device 2, or a server 3. The home appliance 100 may include a user interface (e.g., the user interface 400) that receives a user input or outputs information to a user. The home appliance 100 may include a processor (e.g., the processor 310) that controls an operation of the home appliance 100, and memory (e.g., the memory 320) that stores a program for controlling the operation of the home appliance 100.

The home appliance 100 may be at least one of various types of home appliances. For example, as shown in the accompanying drawings, the home appliance 100 may include at least one of a refrigerator 101, a dishwasher 102, an electric range 103, an electric oven 104, an air conditioner 105, a shoe care apparatus 106, a washing machine 107, a dryer 108, a microwave oven 109, or a clothes treating apparatus 110.

The home appliance 100 is not limited to those illustrated in FIG. 13. For example, the home appliance 100 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 100 according to an embodiment.

The server 3 may communicate with another server, the home appliance 100, or the user device 2. The server 3 may process data received from another server, the home appliance 100, or the user device 2, and may store programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 100 in association with the user account, managing or controlling the registered home appliance 100, and the like. For example, a user may access the server 3 via the user device 2 and may create a user account. The user account may be identified by an identifier (ID) and a password set by the user. The server 3 may register the home appliance 100 with the user account according to a predetermined procedure. For example, the server 3 may link identification information of the home appliance 100 (e.g., a serial number or MAC address) to the user account to register, manage, and control the home appliance 100. The user device 2 may communicate with the home appliance 100 or the server 3. The user device 2 may receive a user input or output information to a user.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The user device 2 may store a program for controlling the home appliance 100, i.e., an application. The application may be sold installed on the user device 2, or may be downloaded from an external server for installation.

By running the application installed on the user device 2 by a user, the user may access the server 3, create a user account, and communicate with the server 3 based on the login user account to register the home appliance 100.

For example, by operating the home appliance 100 to allow the home appliance 100 to access the server 3 according to a procedure guided by the application installed on the user device 2, the server 3 may register the home appliance 100 with the user account by assigning the identification information (e.g., a serial number or a MAC address) of the home appliance 100 to the corresponding user account.

A user may control the home appliance 100 using the application installed on the user device 2. For example, by logging into a user account with the application installed on the user device 2, the home appliance 100 registered in the user account appears, and by inputting a control command for the home appliance 100, the control command may be delivered to the home appliance 100 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth (IEEE 802.15.1), Zigbee (IEEE 802.15.4), Wi-Fi Direct, near field communication (NFC), and Z-Wave, but is not limited thereto.

The AP may connect the home appliance 100 or the user device 2 to a WAN connected to the server 3. The home appliance 100 or the user device 2 may be connected to the server 3 via a WAN.

The AP may communicate with the home appliance 100 or the user device 2 using wireless communication, such as Wi-Fi (IEEE 802.11), Bluetooth (IEEE 802.15.1), Zigbee (IEEE 802.15.4), and the like, and access a WAN using wired communication, but is not limited thereto.

According to various embodiments, the home appliance 100 may be directly connected to the user device 2 or the server 3 without going through an AP.

The home appliance 100 may be connected to the user device 2 or the server 3 via a long-range wireless network or a short-range wireless network.

For example, the home appliance 100 may be connected to the user device 2 via a short-range wireless network (e.g., Wi-Fi Direct).

In another example, the home appliance 100 may be connected to the user device 2 or the server 3 via a WAN using a long-range wireless network (e.g., a cellular communication module).

In still another example, the home appliance 100 may access a WAN using wired communication, and may be connected to the user device 2 or the server 3 via a WAN.

When accessing a WAN using wired communication, the home appliance 100 may also act as an AP. Accordingly, the home appliance 100 may connect another home appliance to a WAN to which the server 3 is connected. In addition, another home appliance may connect the home appliance 100 to the WAN to which the server 3 is connected.

The home appliance 100 may transmit information about an operation or state to other home appliances, the user device 2, or the server 3 via the network. For example, the home appliance 100 may transmit information about an operation or state to other home appliances, the user device 2 or the server 3 upon receiving a request from the server 3, in response to an event in the home appliance 100, or periodically or in real time. Upon receiving the information about the operation or state from the home appliance 100, the server 3 may update the stored information about the operation or state of the home appliance 100 and transmit the updated information about the operation and state of the home appliance 100 to the user device 2 via the network. Here, updating the information may include various operations in which existing information is changed, such as adding new information to the existing information, replacing the existing information with new information, and the like.

The home appliance 100 may obtain various information from other home appliances, the user device 2, or the server 3, and may provide the obtained information to a user. For example, the home appliance 100 may obtain information related to a function of the home appliance 100 (e.g., recipes, washing instructions, etc.) from the server 3 and various environmental information (e.g., weather, temperature, humidity, etc.), and may output the obtained information via a user interface.

The home appliance 100 may operate in accordance with a control command received from other home appliances, the user device 2, or the server 3. For example, the home appliance 100 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 100 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 100, the user device 2, or the server 3 may use techniques, such as artificial intelligence (AI) to determine a control command. For example, the server 3 may receive information about an operation or a state of the home appliance 100 or information about a user of the user device 2, process the received information using techniques, such as AI, and transmit a processing result or a control command to the home appliance 100 or the user device 2 based on the processing result.

According to an embodiment of the disclosure, a drying apparatus may include: a chamber; a first electrode and a second electrode arranged in the chamber, and facing each other and spaced apart from each other; a power supply configured to apply a voltage to the first electrode and the second electrode; and a controller configured to control the power supply, wherein the second electrode may include a first sub-electrode and a second sub-electrode that are arranged adjacent to each other in a direction parallel to the first electrode, and the controller may be configured to control the power supply to apply a first voltage to the first sub-electrode and to apply the first voltage or a second voltage to the second sub-electrode, the second voltage having a different phase from the first voltage.

The controller may be configured to control the power supply to apply a ground voltage to the first electrode, to apply the first voltage to the first sub-electrode and the second sub-electrode to allow a vertical electric field to be formed between the first electrode and the second electrode, or to apply the first voltage to the first sub-electrode and the second voltage to the second sub-electrode to allow a rotating electric field to be formed between the first electrode and the second electrode.

The controller may be configured to control the power supply to apply the first voltage to the first sub-electrode, and to alternately apply the first voltage and the second voltage to the second sub-electrode.

The controller may be configured to control the power supply to apply the first voltage to the first sub-electrode and the second sub-electrode during a first drying time, and to apply the first voltage to the first sub-electrode and the second voltage to the second sub-electrode during a second drying time.

The controller may be configured to determine the first drying time and the second drying time based on a power supplied to the first electrode and the second electrode.

The controller may be configured to control the power supply to apply the first voltage to the first sub-electrode and the second sub-electrode during a first reference time, and to apply the first voltage to the first sub-electrode and the second voltage to the second sub-electrode during a second reference time, and may determine the first drying time and the second drying time based on a first power, supplied to the first electrode and the second electrode during the first reference time, and a second power supplied to the first electrode and the second electrode during the second reference time.

The controller may be configured to determine the first drying time and the second drying time based on a ratio of the second power to the first power.

The controller may be configured to determine the first drying time and the second drying time based on the power supplied to the first electrode and the second electrode at every reference period.

The controller may be configured to determine the first drying time and the second drying time based on a drying course selected by a user.

According to an embodiment of the disclosure, in a method for controlling a drying apparatus including a chamber, a first electrode and a second electrode arranged in the chamber, and facing each other and spaced apart from each other, and a power supply configured to apply a voltage to the first electrode and the second electrode, the second electrode including a first sub-electrode and a second sub-electrode that are arranged adjacent to each other in a direction parallel to the first electrode, the method may include: controlling the power supply to apply a first voltage to the first sub-electrode and the second sub-electrode; and controlling the power supply to apply the first voltage to the first sub-electrode and to apply a second voltage to the second sub-electrode, the second voltage having a different phase from the first voltage.

The controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode may include: controlling the power supply to apply a ground voltage to the first electrode, to apply the first voltage to the first sub-electrode and the second sub-electrode to allow a vertical electric field to be formed between the first electrode and the second electrode, or to apply the first voltage to the first sub-electrode and the second voltage to the second sub-electrode to allow a rotating electric field to be formed between the first electrode and the second electrode.

The controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode may include: controlling the power supply to apply the first voltage to the first sub-electrode, and to alternately apply the first voltage and the second voltage to the second sub-electrode.

The controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode may include: controlling the power supply to apply the first voltage to the first sub-electrode and the second sub-electrode during a first drying time, and to apply the first voltage to the first sub-electrode and the second voltage to the second sub-electrode during a second drying time.

The method may further include determining the first drying time and the second drying time based on a power supplied to the first electrode and the second electrode.

The determining of the first drying time and the second drying time based on the power supplied to the first electrode and the second electrode may include: controlling the power supply to apply the first voltage to the first sub-electrode and the second sub-electrode during a first reference time; controlling the power supply to apply the first voltage to the first sub-electrode and the second voltage to the second sub-electrode during a second reference time; and determining the first drying time and the second drying time based on a first power, supplied to the first electrode and the second electrode during the first reference time, and a second power supplied to the first electrode and the second electrode during the second reference time.

The determining of the first drying time and the second drying time based on a first power, supplied to the first electrode and the second electrode during the first reference time, and the second power supplied to the first electrode and the second electrode during the second reference time may include: determining the first drying time and the second drying time based on a ratio of the second power to the first power.

The determining of the first drying time and the second drying time based on the power supplied to the first electrode and the second electrode may include: determining the first drying time and the second drying time based on the power supplied to the first electrode and the second electrode at every reference period.

The method may further include determining the first drying time and the second drying time based on a drying course selected by a user.

Meanwhile, the disclosed embodiments may be implemented in the form of a recording medium that stores instructions executable by a computer. The instructions may be stored in the form of program codes, and when executed by a processor, the instructions may generate a program module to perform the operations of the disclosed embodiments. The recording medium may be implemented as a computer-readable storage media.

The computer-readable storage media may include all kinds of recording media storing instructions that can be interpreted by a computer. For example, the computer-readable recording medium may be read only memory (ROM), random access memory (RAM), a magnetic tape, a magnetic disc, flash memory, an optical data storage device, etc.

The computer-readable storage medium may be provided in the form of a non-transitory storage medium. Here, when a storage medium is referred to as “non-transitory,” it may be understood that the storage media is tangible and does not include a signal (e.g., an electromagnetic wave), but rather that data is semi-permanently or temporarily stored in the storage media. For example, a “non-transitory storage media” may include a buffer in which data is temporarily stored.

The method according to various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a storage medium, such as memory of a server of a manufacturer, a server of an application store, or a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A drying apparatus, comprising:
a chamber;
a first electrode and a second electrode arranged in the chamber, and facing each other and spaced apart from each other;
a power supply configured to apply a voltage to the first electrode and the second electrode;
memory, comprising one or more storage media, storing instructions; and
one or more processors communicatively coupled to the power supply, the first electrode, the second electrode, and the memory,
wherein the second electrode comprises a first sub-electrode and a second sub-electrode that are arranged adjacent to each other in a direction parallel to the first electrode, and
wherein the instructions, when executed by the one or more processors individually or collectively, cause the drying apparatus to control the power supply to apply a first voltage to the first sub-electrode and to apply the first voltage or a second voltage to the second sub-electrode, the second voltage having a different phase from the first voltage.

2. The drying apparatus of claim 1, wherein the instructions, when executed by the one or more processors individually or collectively, further cause the drying apparatus to:
control the power supply to apply a ground voltage to the first electrode;
control the power supply to apply the first voltage to the first sub-electrode and the second sub-electrode to allow a vertical electric field to be formed between the first electrode and the second electrode; or
control the power supply to apply the first voltage to the first sub-electrode and the second voltage to the second sub-electrode to allow a rotating electric field to be formed between the first electrode and the second electrode.

3. The drying apparatus of claim 1, wherein the instructions, when executed by the one or more processors individually or collectively, further cause the drying apparatus to:
control the power supply to apply the first voltage to the first sub-electrode; and
control the power supply to alternately apply the first voltage and the second voltage to the second sub-electrode.

4. The drying apparatus of claim 1, wherein the instructions, when executed by the one or more processors individually or collectively, further cause the drying apparatus to:
control the power supply to apply the first voltage to the first sub-electrode and the second sub-electrode during a first drying time; and
control the power supply to apply the first voltage to the first sub-electrode and the second voltage to the second sub-electrode during a second drying time.

5. The drying apparatus of claim 4, wherein the instructions, when executed by the one or more processors individually or collectively, further cause the drying apparatus to determine the first drying time and the second drying time based on a power supplied to the first electrode and the second electrode.

6. The drying apparatus of claim 5, wherein the instructions, when executed by the one or more processors individually or collectively, further cause the drying apparatus to:
control the power supply to apply the first voltage to the first sub-electrode and the second sub-electrode during a first reference time;
control the power supply to apply the first voltage to the first sub-electrode and the second voltage to the second sub-electrode during a second reference time; and
determine the first drying time and the second drying time based on a first power, supplied to the first electrode and the second electrode during the first reference time, and a second power supplied to the first electrode and the second electrode during the second reference time.

7. The drying apparatus of claim 6, wherein the instructions, when executed by the one or more processors individually or collectively, further cause the drying apparatus to determine the first drying time and the second drying time based on a ratio of the second power to the first power.

8. The drying apparatus of claim 5, wherein the instructions, when executed by the one or more processors individually or collectively, further cause the drying apparatus to determine the first drying time and the second drying time based on the power supplied to the first electrode and the second electrode at every reference period.

9. The drying apparatus of claim 4, wherein the instructions, when executed by the one or more processors individually or collectively, further cause the drying apparatus to determine the first drying time and the second drying time based on a drying course selected by a user.

10. A method for controlling a drying apparatus comprising a chamber, a first electrode and a second electrode arranged in the chamber, and facing each other and spaced apart from each other, and a power supply configured to apply a voltage to the first electrode and the second electrode, the second electrode including a first sub-electrode and a second sub-electrode that are arranged adjacent to each other in a direction parallel to the first electrode, the method comprising:
controlling the power supply to apply a first voltage to the first sub-electrode and the second sub-electrode; and
controlling the power supply to apply the first voltage to the first sub-electrode and to apply a second voltage to the second sub-electrode, the second voltage having a different phase from the first voltage.

11. The method of claim 10, wherein the controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode comprises:
controlling the power supply to apply a ground voltage to the first electrode;
controlling the power supply to apply the first voltage to the first sub-electrode and the second sub-electrode to allow a vertical electric field to be formed between the first electrode and the second electrode; or
controlling the power supply to apply the first voltage to the first sub-electrode and the second voltage to the second sub-electrode to allow a rotating electric field to be formed between the first electrode and the second electrode.

12. The method of claim 10, wherein the controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode comprises:
controlling the power supply to apply the first voltage to the first sub-electrode, and to alternately apply the first voltage and the second voltage to the second sub-electrode.

13. The method of claim 10, wherein the controlling of the power supply to apply the first voltage to the first sub-electrode and the second sub-electrode and the controlling of the power supply to apply the first voltage to the first sub-electrode and to apply the second voltage with the different phase from the first voltage to the second sub-electrode comprises:
controlling the power supply to apply the first voltage to the first sub-electrode and the second sub-electrode during a first drying time; and
controlling the power supply to apply the first voltage to the first sub-electrode and the second voltage to the second sub-electrode during a second drying time.

14. The method of claim 13, further comprising:
determining the first drying time and the second drying time based on a power supplied to the first electrode and the second electrode.

15. The method of claim 14, wherein the determining of the first drying time and the second drying time based on the power supplied to the first electrode and the second electrode comprises:
controlling the power supply to apply the first voltage to the first sub-electrode and the second sub-electrode during a first reference time;
controlling the power supply to apply the first voltage to the first sub-electrode and the second voltage to the second sub-electrode during a second reference time; and
determining the first drying time and the second drying time based on a first power, supplied to the first electrode and the second electrode during the first reference time, and a second power supplied to the first electrode and the second electrode during the second reference time.

16. The method of claim 15, further comprising:
controlling the power supply to apply the first voltage to the first sub-electrode and the second sub-electrode during a first reference time;
controlling the power supply to apply the first voltage to the first sub-electrode and the second voltage to the second sub-electrode during a second reference time; and
determining the first drying time and the second drying time based on a first power, supplied to the first electrode and the second electrode during the first reference time, and a second power supplied to the first electrode and the second electrode during the second reference time.

17. The method of claim 16, further comprising determining the first drying time and the second drying time based on a ratio of the second power to the first power.

18. The method of claim 15, further comprising determining the first drying time and the second drying time based on the power supplied to the first electrode and the second electrode at every reference period.

19. One or more non-transitory computer-readable storage media storing one or more computer programs including computer-executable instructions that, when executed by one or more processors of a drying device individually or collectively, cause the drying device to perform operations, the operations comprising:
controlling a power supply of the drying device to apply a first voltage to a first sub-electrode and a second sub-electrode; and
controlling the power supply to apply the first voltage to the first sub-electrode and to apply a second voltage to the second sub-electrode, the second voltage having a different phase from the first voltage.

20. The one or more non-transitory computer-readable storage media of claim 19, the operations further comprising:
controlling the power supply to apply a ground voltage to a first electrode;
controlling the power supply to apply the first voltage to the first sub-electrode and the second sub-electrode to allow a vertical electric field to be formed between the first electrode and a second electrode; or
controlling the power supply to apply the first voltage to the first sub-electrode and the second voltage to the second sub-electrode to allow a rotating electric field to be formed between the first electrode and the second electrode.
